(19) United States
(12) Patent Application Publication
(10) Pub. No.: US 2026/0291781 A1
(43) Pub. Date: Sep. 24, 2026

(54) GENERALIZATION CAPABILITY FOR AI-BASED CHANNEL ESTIMATION VIA MIXTURE OF EXPERTS

(71) Applicant: Samsung Electronics Co., Ltd., Suwon-si (KR)

(72) Inventors: Tianyu Li, Saint-Lin Laurentide (CA); Yan Xin, Princeton, NJ (US); Xiaochuan Ma, Hillsborough, NJ (US); Guanbo Chen, Hillsborough, NJ (US); Jianzhong Zhang, Dallas, TX (US)

(21) Appl. No.: 19/574,060

(22) Filed: Mar. 20, 2026

Related U.S. Application Data
(60) Provisional application No. 63/776,814, filed on Mar. 24, 2025.

(51) Int. Cl. H04L 25/02; G06N 3/045

(52) U.S. Cl. CPC H04L 25/0254; G06N 3/045

(57) ABSTRACT

A method includes receiving, by a first electronic device, a signal from a second electronic device over a channel. The method further includes preprocessing, by the first electronic device, the signal to generate a noisy channel estimate. The method additionally includes estimating, by the first electronic device, the channel based on the noisy channel estimate using a neural network having a mixture of experts (MoE) architecture and a router.

### CROSS-REFERENCE TO RELATED APPLICATION AND CLAIM OF PRIORITY

The present application claims priority under 35 U.S.C. § 119(e) to U.S. Provisional Patent Application No. 63/776,814 filed on Mar. 24, 2025, which is hereby incorporated by reference in its entirety.

### TECHNICAL FIELD

This disclosure relates generally to wireless communication systems. More specifically, this disclosure relates to apparatuses and methods for artificial intelligence (AI) based channel estimation via mixture of experts (MoE) in wireless communication systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides a system and method for AI-based channel estimation via MoE in wireless communication systems.

In one embodiment, a method includes receiving, by a first electronic device, a signal from a second electronic device over a channel. The method further includes preprocessing, by the first electronic device, the signal to generate a noisy channel estimate. The method additionally includes estimating, by the first electronic device, the channel based on the noisy channel estimate using a neural network having a MoE architecture and a router.

In another embodiment, a first electric device is located at a first site and includes: a memory and a processor operably coupled to the memory. The processor is configured to: receive, a signal from a second electronic device over a channel; preprocess the signal to generate a noisy channel estimate; and estimate the channel based on the noisy channel estimate using a neural network having an MoE architecture and a router.

In yet another embodiment, a non-transitory computer readable medium embodying a computer program is provided. The computer program includes program code that, when executed by a processor of a first electronic device, causes the first electronic device to: receive a signal from a second electronic device over a channel; preprocess the signal to generate a noisy channel estimate; and estimate the channel based on the noisy channel estimate using a neural network having an MoE architecture and a router.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example base station according to embodiments of the present disclosure;

FIG. 3 illustrates an example user equipment according to embodiments of the present disclosure;

FIG. 4 illustrates an example network device according to embodiment of the present disclosure;

FIG. 5 illustrates example full-band SRS signals 5 and PUSCH DMRS signals according to example embodiments of the present disclosure;

FIG. 6 illustrates an example framework for MoE-based CE in accordance with example embodiments of the present disclosure;

FIG. 7 illustrates a block diagram of an example Resnet-based CE method in accordance with example embodiments of the present disclosure;

FIG. 8 illustrates an example MoE framework for CE with CNNs as a router in accordance with example embodiments of the present disclosure;

FIG. 9 illustrates example expert utilization frequencies for mixed SNRs case without mixed architecture in accordance with example embodiments of the present disclosure;

FIG. 10 illustrates example expert utilization statuses for mixed SNRs case without mixed architecture in accordance with example embodiments of the present disclosure;

FIG. 11 illustrates an example NAFNet architecture and an example NAFNet block architecture 1140 utilized for generalizing multiple RB sizes in CE in accordance with example embodiments of the present disclosure;

FIG. 12 illustrates an example pipeline for MoE CE with shared experts in accordance with the present disclosure;

FIG. 13 illustrates an example layer-wise MoE architecture for CE tasks in accordance with example embodiments of the present disclosure; and

FIG. 14 illustrates an example flow chart for an AI-aided channel estimation method via MoEs according to embodiments of the present disclosure.

### DETAILED DESCRIPTION

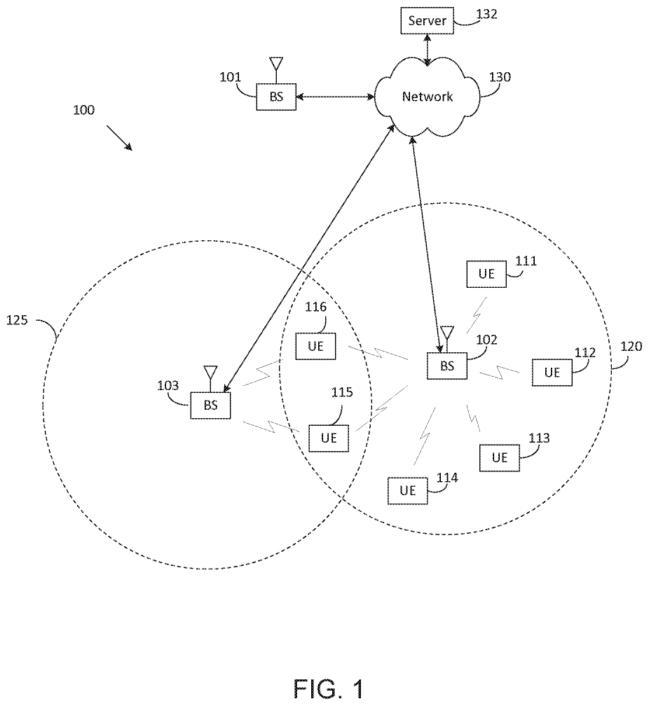

FIGS. 1 through 14, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB (e.g., base station, BS) 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

The wireless network 100 may be an AI-based cellular system. As such, the at least one network 130 may be operably coupled to a network device (e.g., without limitation, a server) 132 configured to, for example and without limitation, receive data from the gNBs 101-103 via backhaul/network interfaces and train and/or test an AI model to perform channel estimation. The server 132 may represent one or more servers, and each server 132 includes a suitable computing or processing device for training and/or testing the AI model. Each server 132 could, for example, include one or more processing devices, one or more memories storing instructions and data, and one or more network interfaces to receive the data. The AI model can then be trained, tested and deployed to effectively perform channel estimation for reliable and efficient communications in the wireless communication network 100.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support the gNB 101-103 for performing wireless communications tasks. In certain embodiments, one or more of the gNBs 101-103 include circuitry, programing, or a combination thereof, to perform AI-based channel estimation (CE) in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

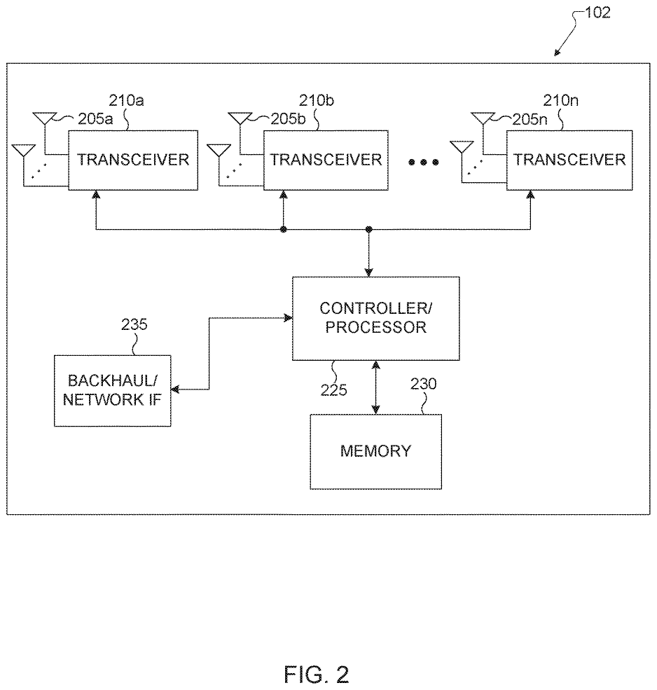

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to perform AI aided channel estimation as discussed further in detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

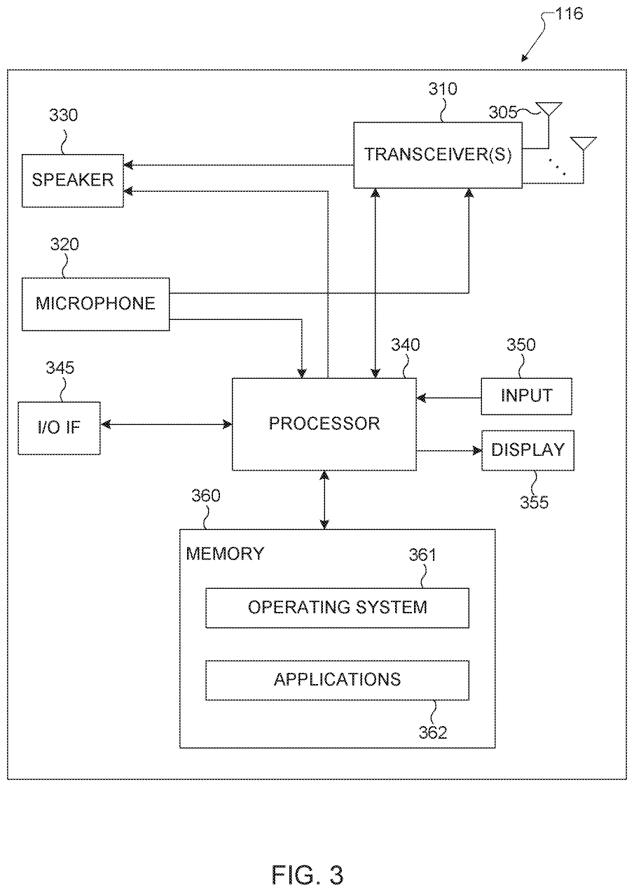

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support the AI-aided channel estimation method as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

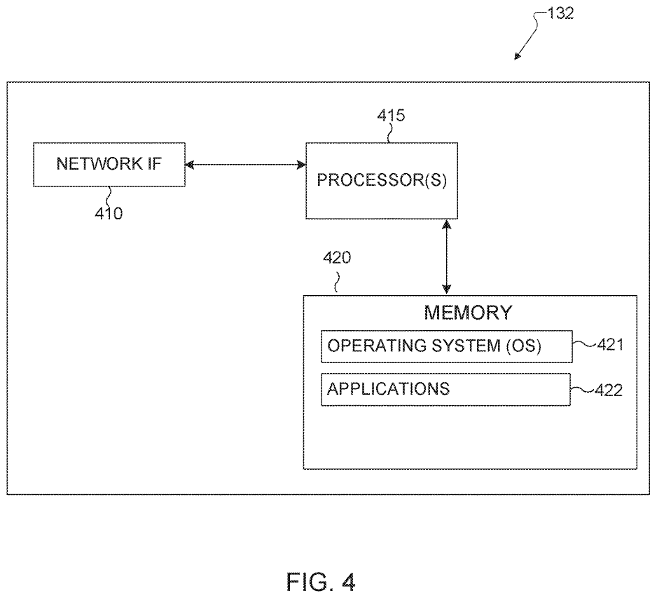

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410, the UEs 111-116 via the gNBs 101-103, or any other appropriate sources. The server 132 may also train and/or test an AI model to perform channel estimation using the MoEs as discussed further in detail below.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network such as an AI CE model as well as a CPU, a GPU or a tensor processing unit (TPU) that provides significant computational resources required for training the AI CE model.

The processor 415 is also capable of executing other processes and programs resident in the memory 420, such as operations that receive and store data. As described in greater detail below, the processor 415 may execute processes to train and/or test an AI model to perform channel estimation in the wireless communication systems. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for the AI model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

In the modern wireless communication such as those described regarding FIGS. 1-4, channel estimation (CE) plays a critical role in ensuring reliable and efficient communications, particularly in scenarios where the wireless channel conditions vary rapidly in an unpredictable manner. In practice, CE often relies on pilot signals, which are known symbols to the receiver inserted into the transmitted signals, allowing the receiver to measure the channel response at specific time, frequency, and/or spatial grids. The channel responses between pilot signals can be subsequently obtained using interpolation. In many cases of practical interests, such as PUSCH DMRS based uplink CE in LTE/NR wireless systems, the number of the DMRS symbols varies depending on several factors including UE channel bandwidth, subcarrier spacing, the number of antennas, and the number of resource blocks allocated. This leads to varying input sizes when performing CE.

CE solutions including least squares (LS) based CE and linear minimum mean square error (LMMSE) CE are based on predetermined signal models and are susceptible to modeling errors. LS based CE solutions aim to minimize the squared error between the received signal and the estimated channel response, while LMMSE based CE solution is a more advanced solution compared to its LS estimation counterpart, targeting to improve estimation accuracy by considering the statistical properties of the channel and the noise. Both LS-based and LMMSE-based CE solutions assume a linear model of the received signals corrupted by additive noise.

AI/machine learning (ML) techniques have been used to develop channel estimation solutions. AI/ML-based channel estimation solutions, which adapt and learn from the wireless channel's characteristics using a massive amount of historical channel data, are capable of achieving superior estimation accuracy and robust to modeling errors, varying channel conditions, and interferences. In particular, deep neural networks (DNN), including multi-layer perceptron (MLP), convolutional neural networks (CNNs) and recurrent neural networks (RNNs), have been proposed for developing advanced CE solutions. These neural networks may learn complex relationships between received signals and channel characteristics, allowing for accurate and efficient estimation.

However, some AI-based approaches may only focus on applying to limited scenarios and their ability to generalize to multiple settings or unseen settings has been largely ignored. In practical wireless systems, the AI-based solution may be utilized to generalize to multiple different scenarios. For example, one model might be expected to perform well across a wide range of SNRs, or various resource block sizes, or additionally different channel profiles. In some AI-based approaches, either each different scenario may utilize a dedicated model, or a model may be trained with the data sampled from all of these scenarios and force to capture all the relevant information. The former solution may introduce severe memory and computation overhead, while the latter may suffer from a significant performance loss due to the forced generalizability. Therefore, equipping AI-based solutions with the advanced capability to generalize to different scenarios is of critical importance for the modern 6G communication.

The present disclosure describes methods for estimating channel state information using neural networks designed to generalize to various scenarios, including different signal-to-noise ratios (SNRs), resource block (RB) sizes and channel profiles, etc. In wireless communication systems, there is a critical need for a model to generalize to various channel conditions, including SNRs, RB sizes and the specific channel profiles. Some AI-based approaches may train specific models for specific scenarios, which significantly increase the storage and computation overhead. Some AI-based approaches may try to force one model to generalize to multiple scenarios by directly training on all of the combined data, which can lead to poor performance. The present disclosure provides to leverage a MoE framework which may be combined with arbitrary neural network architectures for CE and obtain significantly improved results when generalizing to various scenarios.

By leveraging a gating mechanism and adaptive subnetworks (experts) selection, the example MoE frameworks in accordance with the present disclosure may achieve a significant performance gain in terms of CE accuracy over other AI-based approaches on cross SNRs, cross RB sizes and cross channel profiles generalization tasks. Additionally, by utilizing an expert bias scheduling strategy for the auxiliary loss-free method on the expert's load balancing problem, the example MoE frameworks may lead to a stable training process and a great final performance. Further, the performance of the example MoE frameworks may also be further improved by allowing some expert subnetworks to be shared across all input samples (the shared expert subnetworks may be always selected). In addition, by providing a layer-wise MoE-based CE framework, the example embodiments of the present disclosure may improve CE accuracy under low SNR cases.

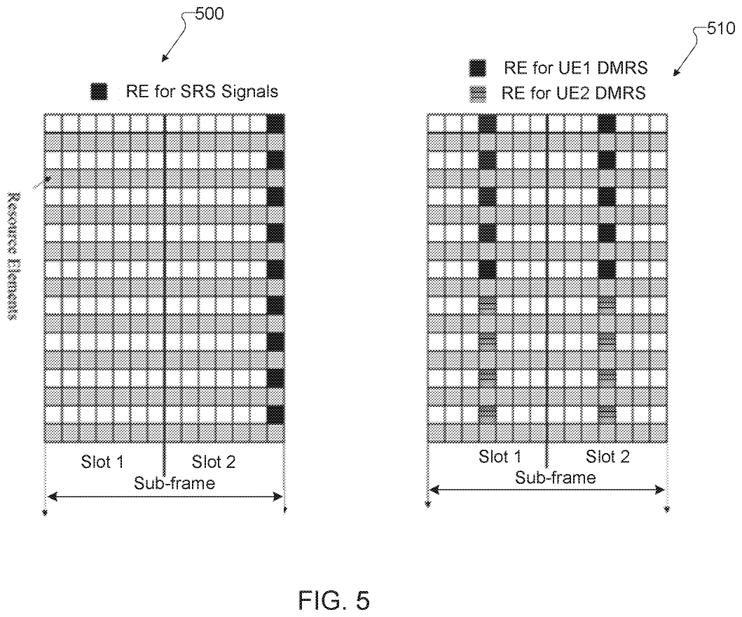

FIGS. 5-14 illustrate non-limiting embodiments of the AI-based CE approaches using MoEs, the resultant benefits, and related concepts thereof in greater detail in accordance with the present disclosure.

FIG. 5 illustrates example full-band SRS signals 500 and PUSCH DMRS signals 510 according to example embodiments of the present disclosure. The example signals 500, 510 shown in FIG. 5 are for illustration only. For example, different numerologies with different subcarrier spacings, slot duration and number of slots per subframe may be supported. Other embodiments of UL OFDM slot structures could be used without departing from the scope of this disclosure.

A wide range of AI/ML-driven techniques have been developed for CE in OFDM systems, offering improved performance in time-varying and high-mobility scenarios as compared some other CE solutions. Mathematically, the input-output relationship between transmitted and received signals at pilot tones in the frequency domain may be written as:

$${Y}_{p} = {H}_{p} ∘ {X}_{p} + {W}_{p} , \qquad Eq . ( 1 )$$

Here, Yₚ∈ [symbol] ^{N}^{_{pf}}^{×N}^{ₚₙ} are the received signals at pilot tones (subcarriers) across either antenna or time, Hₚ∈ [symbol] ^{N}^{_{pf}}^{×N}^{ₚₙ} denote the channel matrix across either antenna or time (OFDM symbols), the operator ∘ represents the Hadamard product that is an element-wise product, Xₚ∈ [symbol] ^{N}^{_{pf}}^{×N}^{ₚₙ} are the transmitted pilot signals known to the receiver, and Wₚ∈ [symbol] ^{N}^{_{pf}}^{×N}^{ₚₙ} is an additive white Gaussian noise (AWGN). Note that in a single-input multiple-output (SIMO) uplink (UL) signal model, Nₚₙ may be used to represent the number of the received antennas while in a single-input single-output (SISO) case, Nₚₙ may be used to represent the number of the OFDM symbols containing pilot tones, respectively. Without loss of generality, for the sake of notational simplicity, in this disclosure, Nₚₙ is replaced by Nₐₙₜ, which refers to the number of received antennas.

As an example, sounding reference signals (SRS) in LTE/NR may be one type of UL pilot signals transmitted from a UE and utilized by eNodeB/gNodeB to estimate the UL channel quality over a bandwidth of interests. SRS-based CE may be used to assist eNodeB/gNodeB UL scheduler for UE resource allocation and to improve DL beamforming. PUSCH demodulation reference signals (DMRS) may be another type of reference signals used for CE and demodulation of UL data.

As shown in FIG. 5, the SRS may be configured to span the full bandwidth with a comb factor 2 and DMRS signals for two UEs are configured to cover the full bandwidth with a comb factor 2.

The goal of CE may be to estimate channel matrix Hₚ based on a pilot signal Xₚ and received signals Yₚ. The simplest CE method may be least-squares (LS) estimation, which minimizes the squared error without requiring channel statistics. The LS estimates of Hₚ, denoted as

$${\hat{H}}_{p}^{LS} ,$$

may be readily computed as:

$${[ {\hat{H}}_{p}^{LS} ]}_{i , j} = \frac{{[ {Y}_{p} ]}_{i , j}}{{[ {X}_{p} ]}_{i , j}}$$

Here, the subscript i, j denotes the (i,j)th entry of a matrix. Essentially, without loss of generality, the entries of Xₚ may be equal to 1 and the LS estimates of Hₚ may be simply written as:

$${\hat{H}}_{p}^{LS} = {H}_{p} + {W}_{p} .$$

Here,

$${\hat{H}}_{p}^{LS}$$

is a N_{pf}×Nₐₙₜ complex matrix. The real and imaginary parts of

$${\hat{H}}_{p}^{LS}$$

may be treated as noisy images, and the real and imaginary parts of Hₚ may be treated as noiseless images. Thus, CE may be formulated as an image denoising problem, where the inputs are noisy images (the real and imaginary parts of

$${\hat{H}}_{p}^{LS}$$

and the outputs are denoised images (the real and imaginary part of estimated channels using AI models).

Note that the solutions in this disclosure may be readily applied to the cases in which the pilot signals Xₚ have non-unit values.

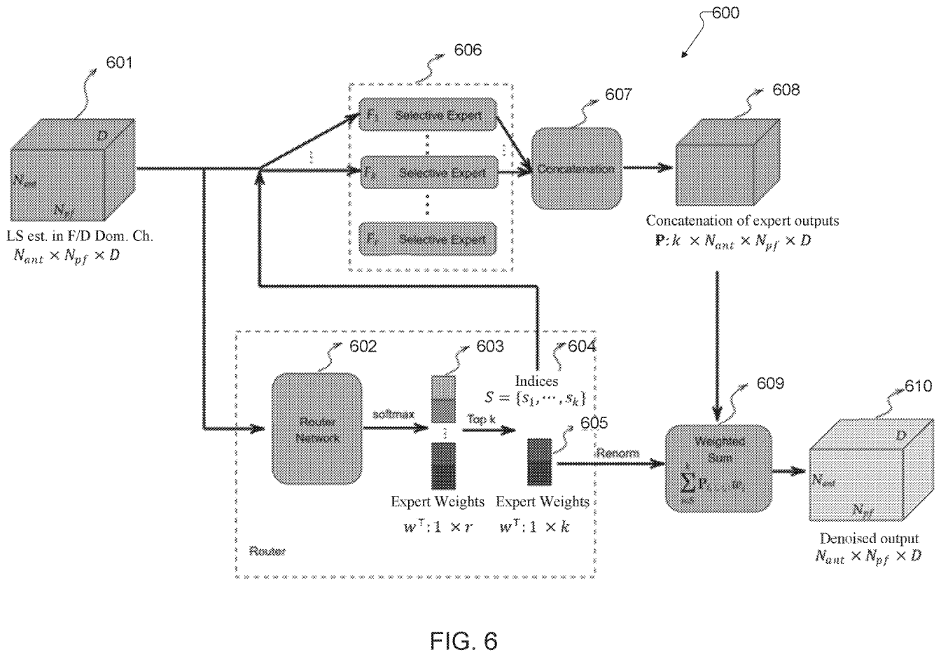

FIG. 6 illustrates an example framework 600 for MoE-based CE in accordance with example embodiments of the present disclosure. The example framework 600 shown in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of MoE-based CE framework could be used without departing from the scope of this disclosure

The MoE architecture may offer a promising solution for CE in wireless communication systems. The MoE may provide adaptive and efficient inference across various scenarios. Some important applications of the MoE in the CE domain are discussed below.

The SNR may significantly impact CE accuracy. A single model trained on a wide range of SNRs may often perform worse as compared to the one trained on only limited SNRs within a narrow range, when evaluating on the same close-ranged SNR levels. This may be largely due to the fact that different SNRs may often utilize different sets of feature representations for CE. For example, in high SNR cases, the model may be utilized to capture more fine-grained details which may often be ignored in the low SNR cases for its difficulty in such cases. Conceptually, the MoE may allow specialized experts to handle different SNR ranges, ensuring reliable inference across diverse channel conditions. By dynamically selecting the appropriate expert, the MoE may enhance adaptability and mitigate performance degradation due to SNR variations.

In practical wireless systems, RB sizes may vary depending on system configurations and bandwidth requirements. A neural network trained on a fixed RB size may perform poorly when the RB size changes. The MoE may address this issue by incorporating multiple experts, which may learn to specialize in different RB sizes during training. The router network may then efficiently allocate computational resources by activating only relevant experts, ensuring optimal performance across varying spatial dimensions.

In addition, wireless channels may exhibit diverse characteristics depending on environmental conditions, mobility, and scattering effects. Some models may struggle to generalize across different channel profiles effectively. The MoE may enable the learning of specialized experts tailored to different channel types (e.g., line-of-sight vs. non-line-of-sight, urban vs. rural environments, indoor vs. outdoor). The router network may dynamically select the most relevant experts, improving generalization and robustness in the cross-channel profile prediction.

Wireless systems often face computational constraints, particularly in edge devices. The MoE may provide an efficient way to allocate computational resources by activating only a subset of experts per inference, reducing overall complexity while maintaining high accuracy. This approach may be beneficial for real-time applications where minimizing latency and power consumption is critical.

The MoE architecture may present a versatile and scalable approach to CE in wireless communication systems. By leveraging specialized experts for diverse channel conditions, varying RB sizes, and different SNR levels, the MoE architecture may enhance generalization, adaptability, and computational efficiency.

An MoE is a neural network architecture that utilizes multiple expert subnetworks, each specializing in different aspects of a problem, with a gating mechanism that dynamically selects which experts to activate for a given input. The core idea may be rooted in the divide-and-conquer principle, where a complex problem may be decomposed into smaller, more manageable subproblems.

Some MoE architectures may be based on transformers and include two main elements: sparse MoE layers and a gating network (a router). On one hand, the sparse MoE layer may include various “expert” blocks. These expert blocks may be parameterized by feed forward networks (FFN) in the transformer architecture, often with the same structure. The router, on the other hand, may determine which input is sent to which expert by outputting a vector of weights for all the experts. Then, a selection of top-k experts may be made based on these weights and only these selected experts may process the input. Finally, the selected experts may aggregate their results together and output to the next layer. Note that the MoE layer may replace the FFN layer in the transformer in order to allow for more specialized modelling without incurring excessive computational overhead. Through expert specialization, the FFN in the MoE layer may likely utilize fewer parameters, further improving the computational efficiency of the transformer.

In large-scale language models, the MoE may be adopted to enhance scalability while maintaining efficiency. Models such as Switch Transformer, GShard, and DeepSeek may leverage MoE architectures to expand the parameter count without a proportional increase in the computational cost. In these architectures, only a small fraction of the experts may be active per token, significantly reducing the per-step floating-point operations (FLOP) consumption compared to a dense model of the similar size. A main benefit of the MoE in language models may be its ability to scale efficiently while mitigating inference costs. By activating only a subset of experts, the MoE architecture may enable models to learn diverse representations across different tokens, capturing nuanced patterns in natural language. However, applying the MoE to large-scale training may introduce new challenges, particularly in expert load balancing and stable training dynamics.

The MoE framework may directly influence the bias-variance tradeoff, a fundamental concept in ML. By design, the MoE may reduce bias by allowing specialized experts to handle distinct input distributions, leading to improved adaptability and task-specific performance. Each expert may effectively capture fine-grained features that a single, monolithic model might struggle with, thus lowering the bias in predictions. However, the MoE may also introduce a variance due to its selective routing mechanism. Since different subsets of experts may be activated for different inputs, the overall model may exhibit a higher variance in predictions, particularly when the gating mechanism may be suboptimal or if experts may not be trained uniformly. This increased variance may lead to instability, resulting in additional techniques such as regularization, improved gating strategies, or balanced expert utilization to ensure robust generalization. A well-optimized MoE model may, thus, aim to strike a balance between these factors by ensuring that experts are both diverse and complementary while avoiding overfitting to particular patterns. Techniques such as expert capacity constraints and controlled sparsity may help mitigate excessive variance while preserving the benefits of expert specialization.

MoE models may be trained to carefully handle the issue of load balancing to prevent uneven expert utilization. If certain experts receive a disproportionate amount of traffic, the model's training efficiency and convergence may degrade. To address this, auxiliary losses may be utilized to encourage balanced expert utilization (e.g., GShard and Switch Transformer). One strategy may include leveraging routing constraints, where the auxiliary losses penalize the imbalanced expert activation. For instance, GShard may utilize a load balancing loss that discourages excessive reliance on a small subset of experts. Additionally, Switch Transformer may simplify the gating mechanism to a top-1 selection, reducing the routing overhead while improving load distribution.

Further, DeepSeek has introduced a load balancing approach by eliminating the need for auxiliary loss-based load balancing. Unlike some MoE models, DeepSeek employs a routing mechanism that may inherently promote balanced expert utilization. Moreover, the auxiliary loss-free approach may minimize the complexities associated with additional balancing losses, leading to more stable and scalable training. Instead of enforcing load balancing through auxiliary objectives, DeepSeek thus leverages an adaptive gating function that naturally distributes computation across experts, enabling the model to maintain high efficiency while preserving the benefits of MoE scaling.

For this, the model may maintain an expert bias, initialized as an all-zero vector of size r, which is the number of experts. Then, after each batch update, the frequency of the selection of each expert may be computed. If the frequency for an expert is higher than a certain threshold τ₁, this expert may be “over utilized”. On the other hand, if the frequency of an expert is lower than a threshold τ₂, this expert may be “underutilized”. For the over utilized experts, the corresponding expert bias may be decreased by γ while for the underutilized experts, the corresponding expert bias may be increased by γ. Then, when selecting the top-k experts, both the router's output weights as well as the expert bias may be considered to determine which experts to select.

In this disclosure, all MoE related frameworks may be trained using the auxiliary loss-based load balancing strategy. The thresholds and γ may be set as

$${τ}_{1} = \frac{2}{r} , {τ}_{2} = \frac{4}{5 r}$$

and γ=0.001. Note that these parameter selection may be based on heurists from various cross validation experiments. Other parameter values may be selected as appropriate.

As shown in FIG. 6, the example framework 600 for MOE-based CE may be flexible and accommodate any backbone ML models, such as Resnet, NAFNet, etc. The core idea may be to construct multiple expert networks, which can adopt various neural network architectures tailored to different aspects of CE, e.g., different RB sizes. A lightweight router network may be responsible for dynamically selecting the top-k most relevant experts during each forward pass, enabling efficient resource allocation and adaptive learning. By dynamically selecting the most suitable experts based on the current input or task, the model may achieve improved generalization and computational efficiency. This framework 600 may be highly flexible and can be applied to various scenarios, such as adapting to different SNR levels, varying RB sizes, and diverse channel profiles. Further, this approach may enhance the robustness and adaptability of CE models in dynamic communication environments. This framework 600 may not only perform well under a multitask set-up, but also have significant performance gain when testing in a zero-shot setting as well.

For CE, the example MoE framework 600 of FIG. 6 may include r selective experts and make top-k selection as following. In operation 601, the framework 600 may receive as input the LS estimate of the channel matrix under either frequency or delay domain, which is of size Nₐₙₜ×N_{pf}×D. Note that D here may be set to 2, indicating the real and imaginary decomposition of the complex channel matrix. Alternatively, D may also be 4 when polarization is introduced. In operation 602, the input may first pass through a router network R: [symbol] ^{N}^{ₐₙₜ}^{×N}^{_{pf}}^{×D}→ [symbol] ^{r}, mapping the input data to a size r vector. In operation 603, after applying softmax function, the expert weights w^{T} may be obtained. In operation 604, the top-k experts may be selected based on the corresponding expert weights and the selected expert indices S={s₁, . . . , sₖ} may be obtained. In operation 605, the corresponding expert weights may be obtained. For the ease of illustration, sᵢ=i, ∀i∈[k], i.e., S={1, 2, . . . , k}, for the current input. Note that the expert selection may vary based on the current input. After obtaining the selected expert indices, the LS estimate input may undergo the forward pass of the selected expert networks. In operation 606, there may be r selective experts, F₁, . . . , Fᵣ: [symbol] ^{N}^{ₐₙₜ}^{×N}^{_{pf}}^{×D}→ [symbol] ^{N}^{ₐₙₜ}^{×N}^{_{pf}}^{×D}, which may be parameterized as arbitrary neural networks. Assuming S={1, 2, . . . , k}, in operation 606, the input may only go through the selected k expert networks, i.e., F₁, . . . , Fₖ and there may be no computation for the remaining r−k networks. In operation 607, k candidate outputs of size [symbol] ^{N}^{ₐₙₜ}^{×N}^{_{pf}}^{×D} may be obtained and concatenated together and form a tensor P∈ [symbol] ^{k×N}^{ₐₙₜ}^{×N}^{_{pf}}^{×D}. In operation 608. The selected expert weights in operation 605 may be renormalized, i.e.,

$${w}^{T} = \frac{{w}^{T}}{〈 w , 1 〉} ,$$

where 1 is an all 1 vector of size k, so that it sums up to 1. Finally In operation 609, a weighted sum may be computed and in operation 610, the final denoised output may be obtained, i.e.

$${\sum }_{i ∈ S}^{k} {P}_{i} {w}_{i} .$$

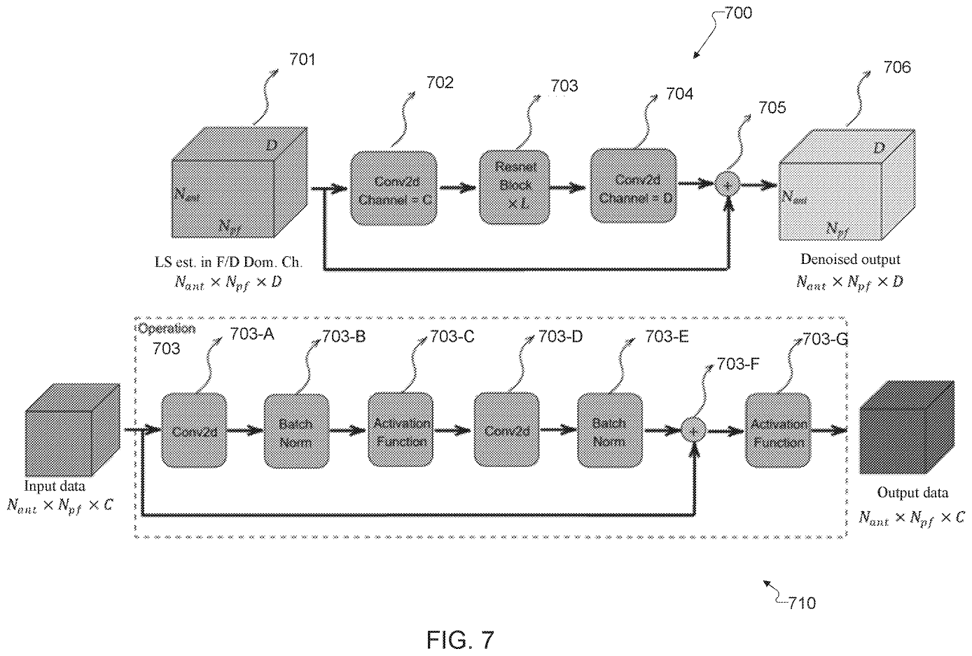

FIG. 7 illustrates a block diagram of an example Resnet-based CE method 700 in accordance with example embodiments of the present disclosure. The example method 700 shown in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of Resnet-based CE methods could be used without departing from the scope of this disclosure.

Resnet, or Residual Network, is a deep learning architecture introduced to address the problem of vanishing gradients that often occurs when training very deep neural networks. The key aspect in Resnet may be the introduction of residual blocks, which allow the network to learn residual functions with reference to the layer inputs, rather than trying to learn unreferenced functions. Each residual block may include shortcut connections that bypass one or more layers, enabling the network to learn identity mappings. This architecture may allow very deep networks to be trained efficiently by mitigating the degradation problem, where increasing depth leads to higher training errors. The primary benefit of Resnet may be that it enables the construction of extremely deep networks, such as Resnet-50, Resnet-101, and even deeper, without suffering from significant vanishing gradients, leading to improved accuracy in complex tasks. Resnet may be utilized widely in various applications, including image classification, object detection, and image denoising/restoration, where its ability to learn deep and complex features may set improved benchmarks in performance.

As shown in FIG. 7, a Resnet may be utilized as the denoising backbone model, i.e., the expert networks. For CE, the method 700 may begin in operation 701. In operation 701, the LS estimate of the channel matrix under either frequency or delay domain, which is of size Nₐₙₜ×N_{pf}×D, may be input to the Resnet. In operation 702, the input signals may be projected to channel size C using a 2 dimensional (2D) convolution layers. In operation 703, a number of Resnet blocks (having the architecture 710) may be stacked. In operations 703-A to 703-E, the input data may be fed through a series of 2D convolution, batch-normalization as well as activation layers. In operation 703-F, a skip connection may be applied to obtain the sum of the layer input and the output features of 703-E, and in operation 703-G the sum may be fed into the activation function and the output of the Resnet block may be obtained. In operation 704, another 2D convolution layer may be applied to project the channel dimension back to size 2 to recover the denoised signals. Finally, in operation 705, a skip connection with respect to the input data in 701 may be applied to obtain the final output in operation 706.

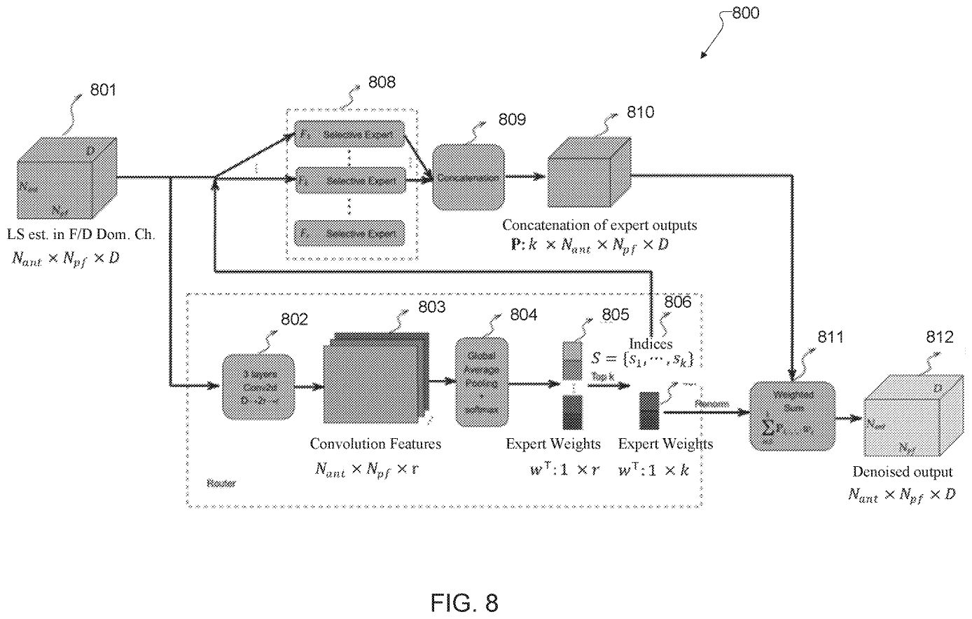

FIG. 8 illustrates an example MoE framework 800 for CE with CNNs as a router in accordance with example embodiments of the present disclosure. The example MoE framework 800 shown in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of MoE framework could be used without departing from the scope of this disclosure.

Building on top of the MoE framework 600 in FIG. 6, the router network may be specified as illustrated in FIG. 8. In operation 801, the LS estimate of the channel matrix under either frequency or delay domain, which is of size Nₐₙₜ×N_{pf}×D, may be input to the router and the selective experts. In operation 802, three layers of 2D CNNs (also referred to as ConvNN) with Relu activation function and batch normalization in between each 2D ConvNN may be utilized. The three layers of ConvNN may project the number of channels from D to 2r then to r and produce the convolutional features in operation 803 of size Nₐₙₜ×N_{pf}×r. In operation 804, a global average pooling with a softmax function may be executed on top of the convolutional features, resulting in a vector output of size r in operation 805. The remaining steps may follow exactly the same operations as those illustrated in FIG. 6. Note that the router network structure illustrated here is just an example. In fact, the architecture of the router may take an arbitrary form, as long as it outputs a vector of size r, representing numerically the importance of each expert given the current input.

This disclosure provides for the generalization capability of the MoE framework on cross SNRs setups. For example, synthetic training data may be generated from UMi channel profile under delay domain, with SNR ranges from −20 dB to 12 dB, taken every 2 dB, namely the training SNRs are [−20 dB, −18 dB, −16 dB, . . . , 10 dB, 12 dB]. The RB size for training and test data may be set to be 40. For evaluation, the NMSE result on a separate test dataset of the same RB size and channel profile may be reviewed. The evaluation SNRs may include [−10 dB, −9 dB, −8 dB, . . . , 13 dB, 14 dB]. In some examples, without other specifications, the training SNR range and the evaluation SNR range may be the same as the setup. For example, a Resnet may be utilized as the backbone model, namely all experts may be parameterized by the Resnet architecture. Specifically, for baseline models, Resnet with 4 Resnet blocks (Resnet-4B) and 8 blocks (Resnet-8B), and the channel size may be set to 16. For all of the MoE experts, Resnet-4B with 16 channel size may be utilized. In some examples, without other specifications, all of the MoE experts may be utilizing Resnet-4B with 16 channel size as the architecture. For training, a learning rate of 0.001 may be utilized with Adam optimizer. When the NMSE comparison is made using the Resnet-MoE architecture with top-1 to top 4 expert selection out of 4 selective experts and the performance of top-⅛ as well as top- 2/8 Resnet MoE structure are evaluated, the MoE based models may achieve improved performance, especially under the high SNR cases. The curve of top ¼ may not be smooth due to the fact that at different SNR levels, the choice of expert changes. Because of the discrete nature of the top-1 selection, the sharp turning point on this curve may be observed. Further, as the selected number of experts is increased, the overall behavior of MoE may improve the performance under low SNR cases while decreasing the performance under high SNR cases. That may be another trade-off in implementing a MoE based architecture. The optimal overall performance may be achieved by a top- 2/8 architecture, as it may strike a balance between the high SNR cases as well as low SNR cases. This may suggest that when there is sufficient training budget/memory, it is often good to have more experts to choose from. Especially note that the computational cost for a forward pass of top- 2/4 and top- 2/8 may be almost the same, albeit a tiny difference may be induced by the router.

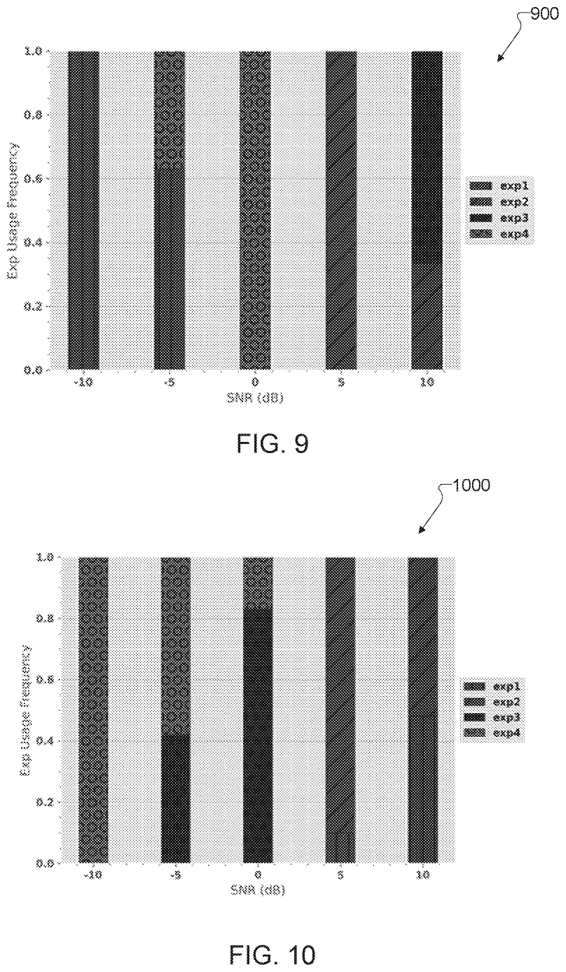

FIGS. 9 and 10 illustrate example expert utilization frequencies 900 and statuses 1000 for mixed SNRs case without mixed architecture in accordance with example embodiments of the present disclosure. The example statuses shown in FIGS. 9 and 10 are for illustration only.

In FIG. 9, the expert utilization frequencies of Resnet MoE top ¼ without mixed architecture (i.e., all subnetworks have the same architecture) are shown. At −10 dB SNR, the router may choose expert 1 for all evaluation input data. This behavior may be gradually shifted to expert 4 at 0 dB SNR. At 5 dB SNR, the router may shift the selection entirely to expert 2. This may subsequently be changed to a mix of expert 2 and expert 3 at 10 dB SNR. Overall, experts 1 and 4 may be often selected for low SNR cases while experts 2 and 3 may be for high SNR cases.

In FIG. 10, example expert utilization statuses for mixed SNRs experiments with MoE of varying architectures are shown. Expert 4 may have the most complex architecture while expert 1 may have the simplest architecture. At −10 dB SNR, the router may utilize the most complex expert, i.e., expert 4, to handle this most challenging task. As the task difficulty decreases (i.e., SNR level increases), the router may begin to utilize less and less complex models, with half and half utilization of experts 1 and 2 at 10 dB SNR level. There may be a sharp change from 0 dB to 5 dB, changing from a mix of experts 3 and 4 to a mix of experts 1 and 2. This may correspond to a sharp turning point at, e.g., 3 dB.

Generalizing to multiple channel profiles in CE may be crucial for ensuring robustness to real-world variability, as wireless channels are influenced by environmental factors such as terrain, mobility, and interference. It may enable scalability across diverse scenarios, including urban, rural, indoor, outdoor, low- and high-mobility environments, allowing a single model to operate effectively without retraining. Additionally, generalization may improve adaptability to dynamic channel conditions caused by user movement, weather changes, and network load, maintaining high performance without frequent updates. It may also reduce training and deployment costs by eliminating the need for multiple specialized models. A well-generalized model may further enhance performance in unknown environments by interpolating or extrapolating to unseen conditions, ensuring reliable operation in unpredictable network deployments. Moreover, it may support next-generation wireless networks, such as 6G, where highly dynamic and heterogeneous environments demand robust models capable of handling different frequency bands, hardware configurations, and propagation conditions

The ability of the MoE architecture disclosed herein to generalize to multiple channel profiles, such as UMi, UMa, CDL-B, CDL-D may be evaluated by first generating synthetic data from all of these channel profiles under delay domain, with SNR ranges from −20 dB to 12 dB. The RB size for both training and evaluation may be still set to 40 and with delay spread set to 300 ns, 300 ns, 600 ns, 10 ns for the respective channel profiles. For the expert's architecture, the Resnet structure having 4 blocks with 16 channels may be used. The training configurations may be the same as well. For multitasking, the trained model on UMi, UMa, CDL-B, CDL-D with the same delay spread as the training data r may be evaluated. For the zero-shot setting, the same trained model but on CDL-B and UMi with 1200 ns delay spread instead may be evaluated. Based on the evaluation, the MoE-based approach may outperform the vanilla method under both multitask setting as well as zero-shot adaptation setting. The gain in performance may be more significant with the increased SNR.

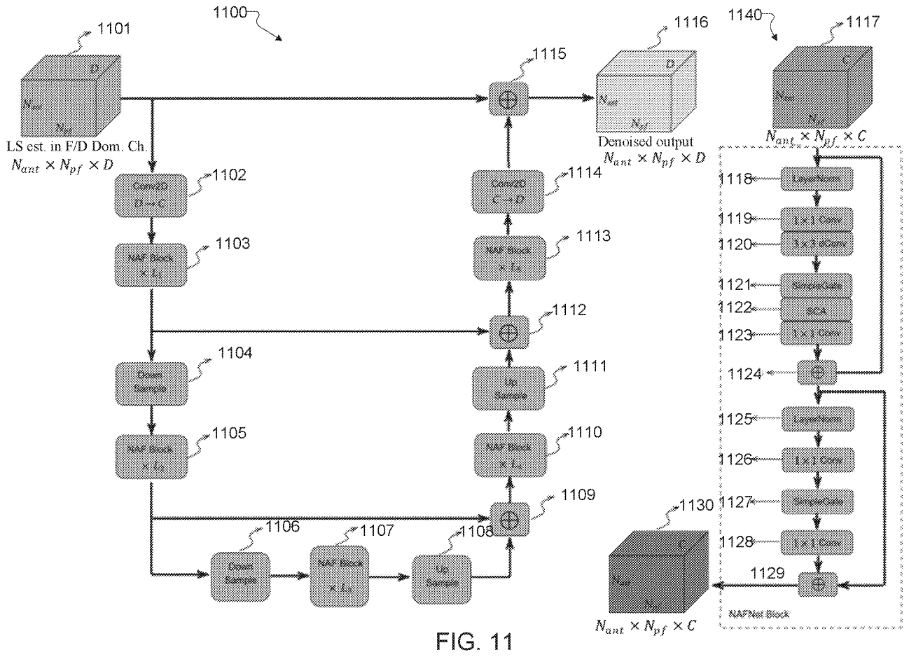

FIG. 11 illustrates an example NAFNet architecture 1100 and an example NAFNet block architecture 1140 utilized for generalizing multiple RB sizes in CE in accordance with example embodiments of the present disclosure. The example NAFNet shown in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of NAFNet could be used without departing from the scope of this disclosure

Generalizing to multiple RB sizes in CE may be essential for ensuring flexibility in network deployment, as different wireless systems allocate varying RB sizes based on bandwidth, user demand, and service requirements. It may enhance scalability across wireless standards, such as 5G NR, which dynamically adjust RB allocations to optimize spectrum usage. Additionally, generalization may improve adaptability to dynamic bandwidth allocation, where RB sizes change due to adaptive modulation, traffic balancing, and spectrum efficiency strategies. A single model that generalizes well across RB sizes may reduce computational costs, storage, and deployment complexity, avoiding the need for separate models. Furthermore, since different RB sizes affect the resolution and frequency selectivity of channel estimation, a generalized model may learn to handle these variations, improving robustness in diverse conditions. Lastly, as future wireless technologies increasingly rely on flexible spectrum allocation, a model capable of generalizing to different RB sizes may ensure long-term compatibility and efficient operation.

In addition to the generalization capability of the MoE architecture to multiple RB sizes, the MoE structure may also provide the flexibility, e.g., in backbone models. For example, instead of using Resnet as the backbone model, NAFNet may be used as the model for the experts. FIG. 11 shows the example NAFNet architecture 1100 as well as the architecture 1140 of the NAFNet block 1117. For this embodiment, the exact same MoE-architecture as illustrated in FIG. 8 may be utilized, except the NAFNet structure being the backbone denoising model instead of Resnet.

NAFNet block may leverage a series of simplified building blocks from a vision literature. The input features to the NAFNet block 1117 may be fed through layer normalization 1118, followed by a convolution layer with 1×1 kernel size 1119 and another depth-wise convolution layer with 3×3 kernel size 1120. Next, in operation 1121, the simple gate operation may divide the input features into two feature tensors with half of the original channel sizes (i.e.,

$${N}_{ant} \times {N}_{pf} \times \frac{c}{2} ,$$

denoted by A and B, respectively), and output A⊙B, where ⊙ denotes the element-wise multiplication. In operation 1122, a simplified channel attention may be performed. The input features may be denoted as F, which is of size Nₐₙₜ×N_{pf}×C, and W∈ [symbol] ^{C×C} may be a linear weight matrix and pool: [symbol] ^{N}^{ₐₙₜ}^{×N}^{_{pf}}^{×C}→ [symbol] ^{C} may be the global average pooling operations. The output of operation 1122 may be F*Wpool (F), where * denotes the channel-wise multiplication. Due to the simple gate operation in operation 1121, the channel size may be halved. Therefore, in operation 1123, another 1×1 convolution network may be applied to map the channel size back to its original size C. In operation 1124, a skip connection may be added with respect to the input features to the NAFNet block (i.e., 1117). Another layer normalization 1125 may then be applied, followed by a 1×1 convolution network 1126. In operation 1127, another simple gate operation may be applied, followed by a 1×1 convolution network 1128 to map the channel size back to its original size. Finally, a skip connection 1129 may be utilized with respect to the output of the other skip connection operation 1124 to obtain the final output feature 1130.

The example NAFNet architecture 1100 shown in FIG. 11 may be similar to U-Net, which leverages a series of downsampling, upsampling and skip connections to extract and utilize high level abstract features and reduce the computational cost. The structure may start with operation 1102 to map the input's channel size to a desired one, resulting in a feature tensor of size Nₐₙₜ×N_{pf}×C. In operation 1103, L₁ number of NAF blocks may be stacked. In operation 1104, downsampling may be performed. Specifically, in this example, for downsampling convolution networks with stride may be utilized to compress the spatial dimension, e.g., both height and width of the image may be reduced by the factor of 2. For upsampling, convolution networks may be transposed to reverse this change in its spatial dimension. Other downsampling and upsampling techniques may also be explored. In operation 1105, L₂ number of NAF blocks may be stacked, followed by downsampling 1106 and another L₃ stack 1107 of the NAF blocks. In operation 1108, upsampling may be performed to increase the spatial dimension. In operation 1109, a skip connection with respect to the output of the operation 1105. In operation 1110, L₄ number of NAF blocks may be stacked, followed by upsampling 1111. In operation 1112, a skip connection may be performed with respect to the output of operation 1103. In operation 1113, another stack of L₅ NAF blocks may be utilized, followed by another Conv2D layer 1114 to project the channel size to the desired one (i.e., D). In operation 1115, a final skip connection may be performed with the input 1101 and the result may be obtained in operation 1116. In this example, for both the baseline models as well as the MoE experts, e.g., C=8, L₁=2, L₂=3, L₃=4, L₄=2, L₅=2.

For this example, the training data generated from a UMi channel with RB sizes of 5, 9, 12, 16, 20 with SNR ranges from −20 dB to 12 dB may be utilized. The validation data may have the same setup as the training data. The performance under both delay domain as well as frequency domain may be compared. For evaluation, data from the same UMi channel but with RB size of 54 may be generated. Vanilla NAFNet and NAFNet MoE of 4 selective experts with top-1 and top-2 selections may be compared. Note that this example may be purely zero-shot setting as the test RB size does not exist in the training RB sizes.

In the cross RB sizes performance evaluation on 54 RBs under frequency domain, a significant performance gain may be shown using NAFNet-MoE compared to its vanilla version. Note that the forward pass complexity between the vanilla NAFNet and NAFNet-MoE top-¼ may be nearly identical, albeit the small router complexity. Though the VRAM usage may be four times the vanilla NAFNet. In the cross RB sizes performance evaluation on 54 RBs under delay domain, when evaluated together with the vanilla NAFNet's performance under frequency domain, the delay domain solution in general may perform worse than frequency domain (baseline NAFNet). However, with the MoE, under the same computational complexity, i.e., top-¼, the delay domain solution may surpass the vanilla frequency domain solution by a significant margin, successfully resolving the error floor issue under high SNRs that the vanilla solution has.

The MoE-CE framework may be understood as a deployable functionality that fits naturally into how devices such as UE and BS process reference signals and obtain reliable channel state information. Its application may begin with the transmission and reception of reference signals, which form the backbone of any channel estimation process. On the DL, the BS may transmit DMRS, CSI-RS, or synchronization signals, which the UE may use to estimate the current DL channel. On the UL, the UE may transmit SRS or UL DMRS, which the BS may use for estimating the UL channel. These reference signals may be inserted into known subcarriers of the OFDM grid, allowing the receiving node to compute an LS estimate of the channel by dividing the received pilot by the known transmitted pilot symbols.

The MoE-CE functionality may operate on this LS estimate as its input. Instead of relying on a monolithic neural network that generalizes across all conditions, the MoE-CE may incorporate multiple expert subnetworks, each trained to specialize in certain channel characteristics, such as different SNR regimes, delay spreads, or resource block configurations. A lightweight router network may analyze the LS estimate and dynamically select the most appropriate subset of experts for the current input. The outputs of the selected experts may then be combined in a weighted manner to produce the final denoised channel estimate. This design may allow the system to exploit specialized processing paths without incurring the computational overhead of evaluating all experts simultaneously.

Control of the MoE mechanism may lie in the router. During training, the router may learn to associate input channel conditions with expert selections. In operation, the router may compute selection weights for each expert based on the observed LS estimate, and only the top-k experts may be activated. To ensure fair usage and prevent over-reliance on certain experts, load balancing strategies such as auxiliary-loss-free bias adjustments may be incorporated into the training process. This may guarantee that different experts remain specialized and useful across deployment conditions.

From an end-to-end perspective, in the DL, the BS may transmit pilots and the UE may receive the pilots. The UE may then compute the LS estimate, and then apply the MoE-CE to recover an enhanced channel estimate. This estimate may be then fed into subsequent receiver modules for demodulation, equalization, or CSI feedback generation. In the UL, the BS may receive UE pilots, perform the LS estimate, and apply the MoE-CE to obtain a refined UL channel estimate, which may be critical for multi-user detection, beamforming, and scheduling. Because the MoE framework may be flexible and agnostic to the backbone model, it may be integrated into both UE and BS sides, supporting UL and DL CE depending on deployment requirements.

The results may be directly tied to the operational characteristics of the BS. For instance, in massive MIMO or wideband 5G/6G systems where hundreds of antennas and varying RB allocations are present, the MoE approach may provide robustness by specializing across RB sizes and SNRs. In zero-shot or unseen deployment scenarios, the router's adaptive selection may enable the system to maintain reliable performance without retraining. In practical terms, this may mean that the UE may benefit from more stable DL demodulation and feedback, while the BS may gain higher reliability in UL detection and scheduling. Thus, the MoE-CE may provide an end-to-end enhancement of the physical layer chain, improving the efficiency and adaptability of the wireless link under real-world conditions.

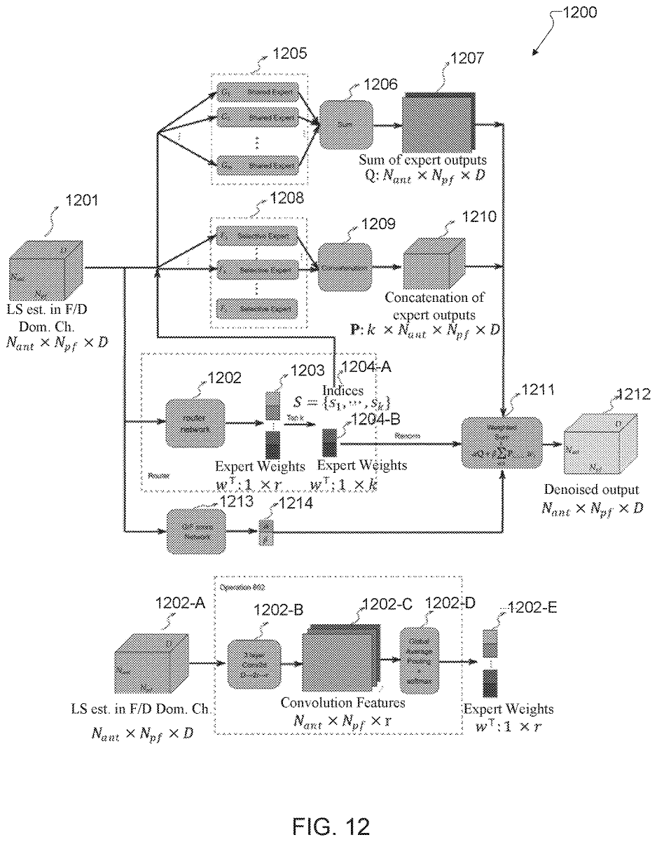

FIG. 12 illustrates an example pipeline 1200 for MoE CE with shared experts in accordance with the present disclosure. The example pipeline shown in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of MoE CE with shared experts could be used without departing from the scope of this disclosure

DeepSeek's MoE architecture may incorporate shared experts to enhance parameter efficiency, enabling knowledge transfer, and optimizing computational performance. Other MoE models may suffer from parameter redundancy, where experts learn similar features independently, leading to inefficiencies. Shared experts may address this by allowing multiple subgroups of tokens to access common expert networks, reducing redundancy while maintaining expressiveness. Furthermore, shared experts may facilitate knowledge transfer across tasks and modalities, enabling the reuse of learned representations and preventing catastrophic forgetting in continual learning scenarios. This design may also enhance generalization, as isolated experts may overfit to specific input distributions, whereas shared experts may encourage robust feature learning across diverse datasets. From a computational perspective, MoE models may often experience expert imbalance, where certain experts receive significantly more activations than others, creating inefficiencies. Shared experts may mitigate this issue by distributing computational loads more evenly, ensuring stable training and inference. Additionally, they may help prevent model collapse, where only a few experts dominate activations. Overall, the integration of shared experts in DeepSeek's MoE architecture may lead to more efficient, balanced, and generalizable learning, making it well-suited for scalable deep learning applications.

In FIG. 12, the example pipeline 1200 of the MoE-CE is similar to the example architectures in FIGS. 6-8 and 11 with one major difference—the introduced shared experts. In operation 1201, the input LS estimate of either frequency or delay domain channel matrix may be provided. Then, same as before, the input may pass through a router network in operation 1202. This router network may take any arbitrary neural network architecture, as long as it outputs a size r expert weights vector in operation 1203. As an example, in operation 1202-B, 3 layers of Conv2d layers may be utilized to map from size D channel to 2r then back to r, with Relu activation and batch normalization in between each layer. The convolution features of size Nₐₙₜ×N_{pf}×r may be obtained in operation 1202-C. Finally, after going through global average pooling and a softmax function in operation 1202-D, the expert weights vector of size r may be obtained in operation 1202-E. Same as before, the top k selective experts may be selected based on their corresponding weights. The input data may then go through the selected experts via forward pass and obtain the concatenation of the outputs generated by the selected selective experts, i.e., P of size k×Nₐₙₜ×N_{pf}×D. Up until this point, the process may be identical to the pipeline introduced in FIG. 8. In addition to the selective experts, the shared experts, i.e., function G₁, . . . , Gₘ may be introduced. These shared experts, same as the selective ones, may take any arbitrary form of neural network architecture. However, different from the selective ones, the input is to be fed through the forward pass of every shared experts, as shown in operation 1205. Then, these results may be summed together in operation 1206, forming Q of size Nₐₙₜ×N_{pf}×D. In operation 1213, the initial input data may be fed to another router named G/F score network, computing the weights of shared experts and selective experts in general. Like the router, this network may take any arbitrary neural network architectures as long as it outputs a size 2 real-valued vector. In operation 1214, the weight α for the shared experts and β for the selective experts may be obtained. and finally combined with the selective experts' output in operation 1211, i.e.,

$$α Q + β {\sum }_{i ∈ S}^{k} {P}_{i} {w}_{i} .$$

Note that when α=0, only the selective experts may be used while when β=0, only the shared experts may be used. In addition, both α and β may depend on the inputs and a set of learnable weights in the G/F score network (operation 613). Thereafter, the final denoised output may be obtained in operation 1212. In this example, the G/F score network may output a size 2 vector of 1, thereby omitting this component.

To compare the performance of the MoE with shared experts and without shared experts, the same setup in the cross-SNR experiment from the example embodiment in FIG. 8. Note that the notation 1s may denote 1 shared expert (without this notation it means that shared experts are not used). For the cross-SNR experiment result, shared expert may decrease the performance under high SNR case. This may be likely due to the rigidity of the contributions for both the shared experts and the selective experts. In the current set up, both the shared experts and the selective experts may contribute to the final output in an equivalent way, i.e., α=β=1. However, under high-SNR scenarios, the CE problem may become more “deterministic”, meaning a fine-grained expert specialization may lead to a better performance. When experts are shared across different SNR ranges, they may likely learn to handle both low-SNR and high-SNR cases, which collapse to the same as the vanilla model. Because of the equal weight assignment in the final output for the shared and selective experts, the fine-grained expert's output may be “diluted” with the shared experts' output, thus reducing the performance on high SNR cases. For example, although MoE-1s-top¼ may have worse performance than MoE-top 2/4 under high SNR scenarios, it may still perform better than Resnet-4B and Resnet-8B, indicating that it may not totally collapse to the vanilla solution. As noted previously, there may be a weight assigned to the shared experts as well as the selective experts, which may depend on the current input. This way, if the SNR is low, it may shift more focus to the shared experts, or if the SNR is high, it may assign more weight to the selective experts' output.

The performance of the MoE 1s Top ¼ with GS router trained from end to end may be evaluated. GS router in this example may be trainable, giving a dynamic weighting on the outputs of the shared networks and the selective networks. In this performance evaluation, Resnet MoE 1s Top ¼ GS may outperform MoE ¼ and MoE 2/4 most of the time, except from 2 dB to 7 dB range. This may be likely due to the fact that the dynamic weighting decides to weight more on the selective expert results instead. As the selective module may be top ¼, this may essentially fall back to the Top ¼ solution. However, note that Is Top¼ GS may outperform top ¼ and top 2/4 on the higher SNRs and lower SNRs range and the weighting on the shared expert output may not be reduced to 0. This may suggest that the added shared expert actually may help alleviating the learning difficulty by reducing the learning task of the selective experts down to learning the residual function between the true target the output of the shared experts. In the dynamic weighting between the output of the shared expert and the output of the selective experts, at low SNR range, the G/S score network may assign higher weight on the output of the shared experts. This weight may gradually be reduced as SNR increases. The sharp changes may occur at around 0 dB SNR.

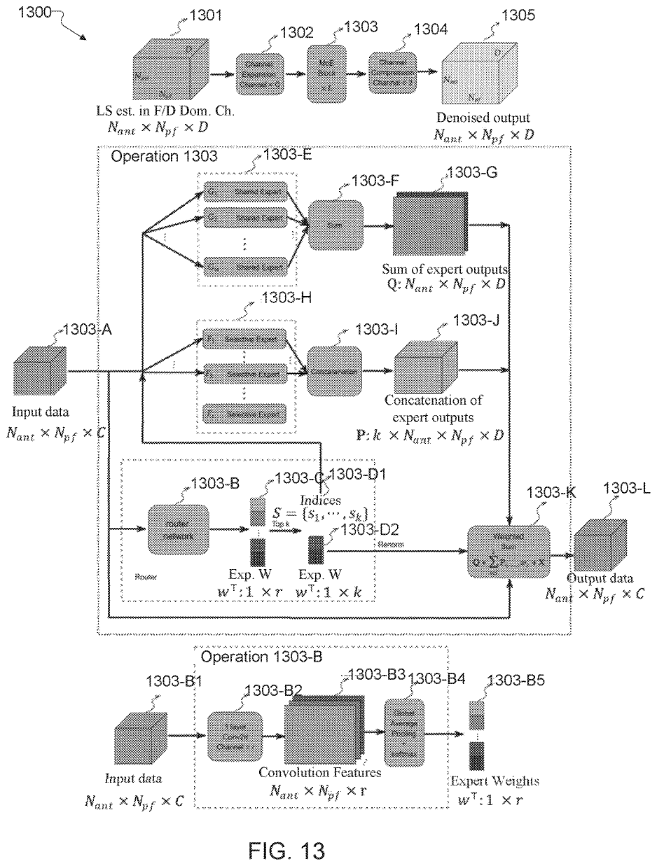

FIG. 13 illustrates an example layer-wise MoE architecture 1300 for CE tasks in accordance with example embodiments of the present disclosure. The example architecture shown in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of layer-wise MoE architecture could be used without departing from the scope of this disclosure.

With the example structure in FIG. 8, the MoE architecture for channel estimation may be evaluated on various multitask and zero-shot scenarios, showing significant improvements using MoE-based approach in all of the experimented scenarios. However, in that example architecture, the MoE idea may be applied in a more global way in the sense that each of the denoising model may be treated as a whole as the expert. Instead, in the original MoE idea, it may be applied in a more fine-grained way such that each layer of a neural network may contain multiple layers of the same structure, posed as different experts of that layer. In other words, instead of having a MoE architecture over the entire neural nets from end to end, the MoE may be applied in a layer-wise fashion.

In the example architecture 1300, the input data first may pass through a channel expansion operation in 1302, expanding the channel size to C, resulting in a feature size of Nₐₙₜ×N_{pf}×C. Then, the features may be put through a series of MoE blocks in operation 1303 and, subsequently, a channel compression operation 1304 to compress the channel size to 2. Finally, the denoised output may be obtained in operation 1305. Note that both the channel expansion and compression operations may be performed using convolutional neural networks. Other forms of these two operations may also be performed as long as the output data of correct shape.

The series of the MoE block operation 1303 is now discussed in further detail. In operation 1303-A, the input feature may be of size Nₐₙₜ×N_{pf}×C. Similar to the end-to-end version of the MoE architecture as illustrated in the previous embodiments, the input feature may first pass through a router, which may include a router network (1303-B) and a top-k selection (1303-C, 1303-D1, 1303-D2). This router network may be selected to have an arbitrary form, but output a vector of size r, which is the number of all selective experts. Similar to before, the input data may be then fed to a series of shared experts and the selected selective experts, chosen by the top-k indices in 1303-D1. Note that the key difference may be that all the experts may be no longer an end-to-end networks mapping from the noisy channel to the denoised output, but they may be now intermediate layers mapping from one feature to another, i.e., [symbol] ^{N}^{ₐₙₜ}^{×N}^{_{pf}}^{×C}→ [symbol] ^{N}^{ₐₙₜ}^{×N}^{_{pf}}^{×C}. Therefore, after summing up the shared experts' outputs, the sum Q: [symbol] ^{N}^{ₐₙₜ}^{×N}^{_{pf}}^{×C} in operation 1303-I, and after the concatenation of selected selective experts, P: [symbol] ^{k×N}^{ₐₙₜ}^{×N}^{_{pf}}^{×C} in operation 1303-J. Finally, like the previous architectures, the selected experts' weight may be renormalized and a weighted sum may be performed in operation 1303-K. The final output feature may then be obtained in operation 1303-L. Note a slight difference may be that DeepSeek's architecture may be utilized and a skip connection may be added in operation 1303-K when performing the weighted sum. This skip connection may be removed if desired.

In one example, Resnet (4 blocks, 16 channels) may be utilized as the backbone model, thereby modifying the Resnet block into Resnet-MoE block. This is for illustration, and other architectures may be utilized by modifying the corresponding MoE-layer with the desired backbone components (e.g., transformer's FFN blocks etc.). In addition, for the experiments of this embodiment, a simple router network 1303-B may be utilized as shown in FIG. 13. The input data 1303-B1 may pass through a one-layer Conv2D layer 1303-B2 mapping the channel size to r, with a subsequent batch normalization and Relu function 1303-B3. This may then be then followed by a global average pooling and a softmax operation 1303-B4, obtaining the expert weights in operation 1303-B5 or size r. For layer-wise MoE under low SNR cases, there may be a performance gain over both the baselines as well as the end to end MoE.

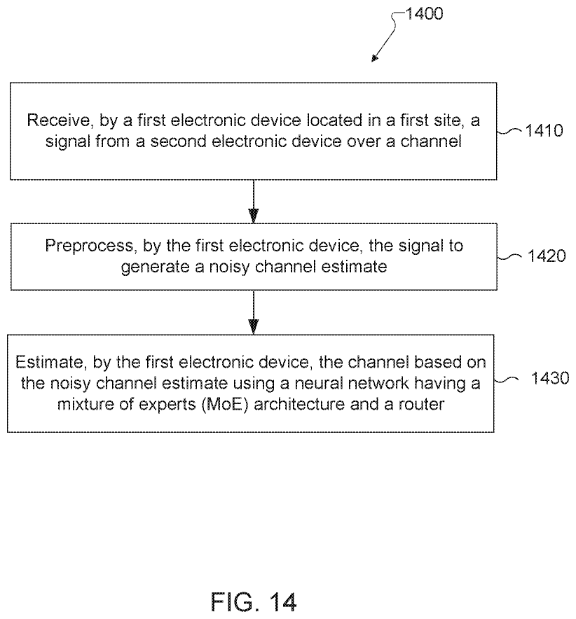

FIG. 14 illustrates an example flow chart for an AI-aided channel estimation method 1400 via MoEs according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of data preparation could be used without departing from the scope of this disclosure.

As illustrated in FIG. 14, the method 1400 begins at step 1410. At step 1410, a first electronic device (e.g., a base station 101-103 of FIGS. 1 and 2 or a UE 111-106 of FIGS. 1 and 3) may receive a signal from a second electronic device (e.g., a base station 101-103 of FIGS. 1 and 2 or a UE 111-106 of FIGS. 1 and 3) on a channel.

At step 1420, the first electronic device may preprocess the signal to generate a noisy channel estimate.

In one embodiment, the router may be a neural network trained to perform load balancing by initializing an expert bias as an all-zero vector having a size equal to a number of expert subnetworks in the MoE architecture, determining a frequency of each expert subnetwork selection, decreasing a corresponding expert bias of an expert subnetwork having the frequency greater than a threshold, or increasing a corresponding expert bias of an expert subnetwork having the frequency less than the threshold, and selecting one or more expert subnetworks based on respective expert weights and the corresponding expert biases.

In one embodiment, the router may be a neural network trained end-to-end to dynamically select one or more expert subnetworks of the MoE architecture and the selected one or more expert subnetworks are trained jointly with the router.

At step 1430, the first electronic device may estimate the channel using a neural network having an MoE architecture and a router.

In one embodiment, the MoE architecture may include expert subnetworks. Each expert subnetwork may be configured to perform a task tailored for a parameter associated with the channel. The parameter may include at least one of a signal-to-noise ratio, a resource block size, and a channel profile. The channel may be estimated by identifying, using the router, a vector of weights for the expert subnetworks based the noisy channel estimate. The channel may be further estimated by selecting, using the router, a first expert subnetwork from the expert subnetworks based on the weights to process respective expert input (the first expert subnetwork having a corresponding weight greater than a weight threshold. The channel may be estimated based on an output from the first expert subnetwork.

In one embodiment, the MoE architecture may include expert subnetworks. Each expert subnetwork may be configured to perform a task tailored for a parameter associated with the channel. The parameter may include at least one of a signal-to-noise ratio, a resource block size, and a channel profile. The channel may be estimated by identifying, using the router, a vector of weights for the expert subnetworks based the noisy channel estimate. The channel may be further estimated by selecting, using the router, first expert subnetworks from the expert subnetworks based on the weights to process respective expert inputs (the first expert subnetworks having corresponding weights greater than a weight threshold). The channel may also be estimated by aggregating outputs from the first expert subnetworks, and computing a weighted sum of the first expert subnetworks to generate a denoised channel output.

In one embodiment, the MoE architecture may include one or more shared expert subnetworks having task-agnostic common knowledge and one or more selective expert subnetworks. Each selective expert subnetwork may be configured to perform a task tailored for a parameter associated with the channel. The parameter may include at least one of a signal-to-noise ratio, a resource block size, and a channel profile. The channel may be estimated by: identifying, using the router, a vector of first weights for the one or more selective expert subnetworks based on the noisy channel estimate; selecting, using the router, one or more first selective expert subnetworks based on the first weights to process respective expert inputs, the first selective expert subnetworks having corresponding first weights greater than a weight threshold; aggregating outputs from the first selective expert subnetworks; forward passing the noisy channel estimate to each shared expert subnetwork; adding outputs from the one or more shared expert subnetworks; feeding the noisy channel estimate to a second router to compute second weights for the one or more selective expert subnetworks and third weights for the one or more shared expert subnetworks; and generating a denoised channel output based on a weighted sum of the outputs from the one or more first selective expert subnetworks and the outputs from the one or more shared expert subnetworks using the second and third weights.

In one embodiment, the MoE architecture is a layer-wise MoE architecture, and expert subnetworks of the MoE architecture are intermediate layers mapping one feature to another feature.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined only by the claims.

What is claimed is:

1. A method comprising:
receiving, by a first electronic device, a signal from a second electronic device over a channel;
preprocessing, by the first electronic device, the signal to generate a noisy channel estimate; and
estimating, by the first electronic device, the channel based on the noisy channel estimate using a neural network having a mixture of experts (MoE) architecture and a router.

2. The method of claim 1, wherein:
the MoE architecture comprises expert subnetworks, each expert subnetwork configured to perform a task tailored for a parameter associated with the channel, the parameter comprising at least one of a signal-to-noise ratio, a resource block size, and a channel profile, and
estimating the channel comprises:
identifying, using the router, a vector of weights for the expert subnetworks based on the noisy channel estimate;
selecting, using the router, a first expert subnetwork from the expert subnetworks based on the weights to process respective expert input, the first expert subnetwork having a corresponding weight greater than a weight threshold; and
estimating the channel based on an output from the first expert subnetwork.

3. The method of claim 1, wherein:
the MoE architecture comprises expert subnetworks, each expert subnetwork configured to perform a task tailored for a parameter associated with the channel, the parameter comprising at least one of a signal-to-noise ratio, a resource block size, and a channel profile, and
estimating the channel comprises:
identifying, using the router, a vector of weights for the expert subnetworks based on the noisy channel estimate;
selecting, using the router, first expert subnetworks from the expert subnetworks based on the weights to process respective expert inputs, the first expert subnetworks having corresponding weights greater than a weight threshold;
aggregating outputs from the first expert subnetworks; and
computing a weighted sum of the first expert subnetworks to generate a denoised channel output.

4. The method of claim 1, wherein the router is a neural network trained to perform load balancing by:
initializing an expert bias as an all-zero vector having a size equal to a number of expert subnetworks in the MoE architecture;
determining a frequency of each expert subnetwork selection;
decreasing a corresponding expert bias of an expert subnetwork having the frequency greater than a threshold, or increasing a corresponding expert bias of an expert subnetwork having the frequency less than the threshold; and
selecting one or more expert subnetworks based on respective expert weights and the corresponding expert biases.

5. The method of claim 1, wherein the router is a neural network trained end-to-end to dynamically select one or more expert subnetworks of the MoE architecture and the selected one or more expert subnetworks are trained jointly with the router.

6. The method of claim 1, wherein
the MoE architecture comprises one or more shared expert subnetworks having task-agnostic common knowledge and one or more selective expert subnetworks, each selective expert subnetwork configured to perform a task tailored for a parameter associated with the channel, the parameter comprising at least one of a signal-to-noise ratio, a resource block size, and a channel profile, and
estimating the channel comprises:
identifying, using the router, a vector of first weights for the one or more selective expert subnetworks based on the noisy channel estimate;
selecting, using the router, one or more first selective expert subnetworks based on the first weights to process respective expert inputs, the first selective expert subnetworks having corresponding first weights greater than a weight threshold;
aggregating outputs from the first selective expert subnetworks;
forward passing the noisy channel estimate to each shared expert subnetwork;
adding outputs from the one or more shared expert subnetworks;
feeding the noisy channel estimate to a second router to compute second weights for the one or more selective expert subnetworks and third weights for the one or more shared expert subnetworks; and
generating a denoised channel output based on a weighted sum of the outputs from the one or more first selective expert subnetworks and the outputs from the one or more shared expert subnetworks using the second and third weights.

7. The method of claim 1, wherein the MoE architecture is a layer-wise MoE architecture, and expert subnetworks of the MoE architecture are intermediate layers mapping one feature to another feature.

8. A first electronic device comprising:
memory; and
a processor operably coupled to the memory, the processor configured to:
receive a signal from a second electronic device over a channel;
preprocess the signal to generate a noisy channel estimate; and
estimate the channel based on the noisy channel estimate using a neural network having a mixture of experts (MoE) architecture and a router.

9. The first electronic device of claim 8, wherein:
the MoE architecture comprises expert subnetworks, each expert subnetwork configured to perform a task tailored for a parameter associated with the channel, the parameter comprising at least one of a signal-to-noise ratio, a resource block size, and a channel profile, and
to estimate the channel, the processor is further configured to:
identify, using the router, a vector of weights for the expert subnetworks based on the noisy channel estimate;
select, using the router, a first expert subnetwork from the expert subnetworks based on the weights to process respective expert input, the first expert subnetwork having a corresponding weight greater than a weight threshold; and
estimate the channel based on an output from the first expert subnetwork.

10. The first electronic device of claim 8, wherein:
the MoE architecture comprises expert subnetworks, each expert subnetwork configured to perform a task tailored for a parameter associated with the channel, the parameter comprising at least one of a signal-to-noise ratio, a resource block size, and a channel profile, and
to estimate the channel, the processor is further configured to:
identify, using the router, a vector of weights for the expert subnetworks based on the noisy channel estimate;
select, using the router, first expert subnetworks from the expert subnetworks based on the weights to process respective expert inputs, the first expert subnetworks having corresponding weights greater than a weight threshold;
aggregate outputs from the first expert subnetworks; and
compute a weighted sum of the first expert subnetworks to generate a denoised channel output.

11. The first electronic device of claim 8, wherein the router is a neural network trained to perform load balancing by:
initializing an expert bias as an all-zero vector having a size equal to a number of expert subnetworks in the MoE architecture;
determining a frequency of each expert subnetwork selection;
decreasing a corresponding expert bias of an expert subnetwork having the frequency greater than a threshold, or increasing a corresponding expert bias of an expert subnetwork having the frequency less than the threshold; and
selecting one or more expert subnetworks based on respective expert weights and the corresponding expert biases.

12. The first electronic device of claim 8, wherein the router is a neural network trained end-to-end to dynamically select one or more expert subnetworks of the ME architecture and the selected one or more expert subnetworks are trained jointly with the router.

13. The first electronic device of claim 8, wherein:
the MoE architecture comprises one or more shared expert subnetworks having task-agnostic common knowledge and one or more selective expert subnetworks, each selective expert subnetwork configured to perform a task tailored for a parameter associated with the channel, the parameter comprising at least one of a signal-to-noise ratio, a resource block size, and a channel profile, and
to estimate the channel, the processor is further configured to:
identify, using the router, a vector of first weights for the one or more selective expert subnetworks based on the noisy channel estimate;
select, using the router, one or more first selective expert subnetworks based on the first weights to process respective expert inputs, the first selective expert subnetworks having corresponding first weights greater than a weight threshold;
aggregate outputs from the first selective expert subnetworks;
forward pass the noisy channel estimate to each shared expert subnetwork;
add outputs from the one or more shared expert subnetworks;
feed the noisy channel estimate to a second router to compute second weights for the one or more selective expert subnetworks and third weights for the one or more shared expert subnetworks; and
generate a denoised channel output based on a weighted sum of the outputs from the one or more first selective expert subnetworks and the outputs from the one or more shared expert subnetworks using the second and third weights.

14. The first electronic device of claim 8, wherein the MoE architecture is a layer-wise MoE architecture, and expert subnetworks of the MoE architecture are intermediate layers mapping one feature to another feature.

15. A non-transitory computer readable medium embodying a computer program, the computer program comprising program code that, when executed by a processor of a first electronic device, causes the first electronic device to:
receive a signal from a second electronic device over a channel;
preprocess the signal to generate a noisy channel estimate; and
estimate the channel based on the noisy channel estimate using a neural network having a mixture of experts (MoE) architecture and a router.

16. The non-transitory computer readable medium of claim 15, wherein:
the MoE architecture comprises expert subnetworks, each expert subnetwork configured to perform a task tailored for a parameter associated with the channel, the parameter comprising at least one of a signal-to-noise ratio, a resource block size, and a channel profile, and
the program code that, when executed by the processor of the first electronic device, causes the first electronic device to estimate the channel comprises program code that, when executed by the processor of the first electronic device, causes the first electronic device to:
identify, using the router, a vector of weights for the expert subnetworks based on the noisy channel estimate;
select, using the router, a first expert subnetwork from the expert subnetworks based on the weights to process respective expert input, the first expert subnetwork having a corresponding weight greater than a weight threshold; and
estimate the channel based on an output from the first expert subnetwork.

17. The non-transitory computer readable medium of claim 15, wherein:
the MoE architecture comprises expert subnetworks, each expert subnetwork configured to perform a task tailored for a parameter associated with the channel, the parameter comprising at least one of a signal-to-noise ratio, a resource block size, and a channel profile, and
the program code that, when executed by the processor of the first electronic device, causes the first electronic device to estimate the channel comprises program code that, when executed by the processor of the first electronic device, causes the first electronic device to:
identify, using the router, a vector of weights for the expert subnetworks based on the noisy channel estimate;
select, using the router, first expert subnetworks from the expert subnetworks based on the weights to process respective expert inputs, the first expert subnetworks having corresponding weights greater than a weight threshold;
aggregate outputs from the first expert subnetworks; and
compute a weighted sum of the first expert subnetworks to generate a denoised channel output.

18. The non-transitory computer readable medium of claim 15, wherein the router is a neural network trained to perform load balancing by:
initializing an expert bias as an all-zero vector having a size equal to a number of expert subnetworks in the MoE architecture;
determining a frequency of each expert subnetwork selection;
decreasing a corresponding expert bias of an expert subnetwork having the frequency greater than a threshold, or increasing a corresponding expert bias of an expert subnetwork having the frequency less than the threshold; and
selecting one or more expert subnetworks based on respective expert weights and the corresponding expert biases.

19. The non-transitory computer readable medium of claim 15, wherein:
the MoE architecture comprises one or more shared expert subnetworks having task-agnostic common knowledge and one or more selective expert subnetworks, each selective expert subnetwork configured to perform a task tailored for a parameter associated with the channel, the parameter comprising at least one of a signal-to-noise ratio, a resource block size, and a channel profile, and
the program code that, when executed by the processor of the first electronic device, causes the first electronic device to estimate the channel comprises program code that, when executed by the processor of the first electronic device, causes the first electronic device to:
identify, using the router, a vector of first weights for the one or more selective expert subnetworks based on the noisy channel estimate;
select, using the router, one or more first selective expert subnetworks based on the first weights to process respective expert inputs, the first selective expert subnetworks having corresponding first weights greater than a weight threshold;
aggregate outputs from the first selective expert subnetworks;
forward pass the noisy channel estimate to each shared expert subnetwork;
add outputs from the one or more shared expert subnetworks;
feed the noisy channel estimate to a second router to compute second weights for the one or more selective expert subnetworks and third weights for the one or more shared expert subnetworks; and
generate a denoised channel output based on a weighted sum of the outputs from the one or more first selective expert subnetworks and the outputs from the one or more shared expert subnetworks using the second and third weights.

20. The non-transitory computer readable medium of claim 15, wherein the MoE architecture is a layer-wise MoE architecture, and expert subnetworks of the MoE architecture are intermediate layers mapping one feature to another feature.
